(19) United States
(12) Patent Application Publication
(10) Pub. No.: US 2024/0157968 A1
(43) Pub. Date: May 16, 2024

(54) DRIVING CONTROL SYSTEM

(71) Applicant: SUBARU CORPORATION, Tokyo (JP)

(72) Inventor: Yu HASEGAWA, Tokyo (JP)

(21) Appl. No.: 18/549,478

(22) PCT Filed: Nov. 4, 2021
(86) PCT No.: PCT/JP2021/040686

§ 371 Date: Sep. 7, 2023

(51) Int. Cl. B60W 60/00; B60W 30/182; B60W 50/14; G01C 21/34; G01C 21/36; H04W 4/44

(52) U.S. Cl. CPC B60W 60/001; B60W 30/182; B60W 50/14; G01C 21/3492; G01C 21/3694; H04W 4/44; B60W 2050/146; B60W 2554/4041; B60W 2554/406; B60W 2556/40; B60W 2556/45

(57) ABSTRACT

A driving control system includes a position information acquiring unit, an another vehicle information acquiring unit, a storage unit, a drawing processing unit, a driving control mode determining unit, a notification unit, and a driving control unit. The drawing processing unit draws a region where a traveling trajectory of an own vehicle in an automated driving mode or a driving assist mode and a traveling trajectory of another vehicle in either mode are plotted on a high-precision map. The driving control mode determining unit determines a driving control mode, based on at least the region and position information of the own vehicle. The notification unit notifies an occupant of the own vehicle when the own vehicle enters or exits the region. The driving control unit controls start and end of automated driving control or driving assist control of the own vehicle when the own vehicle enters or exits the region.

### TECHNICAL FIELD

The invention relates to a driving control system.

### BACKGROUND ART

In recent years, an automated driving vehicle that allows a driver to travel the vehicle without performing a driving operation have been developed. This automated driving control is defined in six stages including level 0, level 1 (assisted driving), level 2 (partially automated driving), level 3 (conditional automated driving), level 4 (highly automated driving), and level 5 (full driving automation). The development of the automated driving control is proceeding rapidly toward the final stage.

On the other hand, a development of a so-called connected car is in progress. An application to an optimum route search technique has been expected, as well as a sophistication of the automated driving control, by integrating information from another vehicle using a technique related to the connected car in addition to a sensor technique used for the automated driving control.

As a technique of this type, a route search system has been disclosed that detects a change in a traveling lane of a vehicle, calculates a traveling avoidance section in which each vehicle should avoid an entry on the basis of traveling lane change information as a detection result thereof, estimates a traveling rule on the basis of an appearance pattern of the traveling avoidance section, and distributes information on the traveling rule to each in-vehicle terminal (for example, see Patent Literature 1).

In addition, a system has been disclosed for constructing a real-time traffic map between a vehicle and cloud for an autonomous driving vehicle. The system senses a driving environment around a plurality of vehicles using a plurality of sensors mounted on the plurality of vehicles that are the autonomous driving vehicles (ADVs), analyzes a situation from the driving environment around an own vehicle, and determines a real-time traffic situation at a certain point in time. The system determines whether the real-time traffic situation of the driving environment matches at least one predetermined traffic situation, transmits data related to the real-time traffic situation to a remote server via a network in a case where it is determined that the real-time traffic situation is unknown to cause the remote server to generate an updated map having the real-time traffic information (for example, see Patent Literature 2).

Further, a traffic guidance system has been disclosed that collects a route along which a vehicle has traveled in the past as a travel history together with a situation of the vehicle at the time of traveling, identifies a route along which the vehicle is predicted to travel in the future on the basis of the travel history corresponding to a current situation of the vehicle in the collected travel history in a case where there is an event in which traveling on a road is to be hindered in front of the vehicle in a traveling direction in view of information on another vehicle or the like or in a case where the vehicle has entered the event in which the traveling on the road is to be hindered, and guides traffic information on the identified route (for example, see Patent Literature 3).

### CITATION LIST

### Patent Literature

Patent Literature 1: Japanese Unexamined Patent Application Publication No. 2019-27904
Patent Literature 2: Japanese Unexamined Patent Application Publication No. 2019-145077
Patent Literature 3: Japanese Unexamined Patent Application Publication No. 2019-185232

### SUMMARY OF INVENTION

### Problem to be Solved by the Invention

However, in a technique described in Patent Literature 1, a calculation process of traveling lane change information, a calculation process of a traveling avoidance section, an estimation process of a traveling rule, etc., are essential processes, and thus there is a problem that a processing load increases.

In addition, in a technique described in Patent Literature 2, there is a problem of an increase in processing load in that, in order to grasp a real-time traffic situation of a driving environment, it is necessary to execute a process of monitoring a vehicle and analyzing acquired information (a reliability determination or the like), a process of determining the real-time traffic situation in the obtained driving environment, etc.

Further, in a technique described in Patent Literature 3, an extraction process of a past travel history, a learning target extraction process, a route identifying process, etc., are essential processes. Accordingly, there is a problem that real-time information is not obtained and a processing load increases.

The invention has been made in view of the problems described above, and it is therefore an object of the invention to provide a driving control system that determines an automated driving possible area or a driving assist possible area in real time while suppressing a processing load, notifies an occupant of start or end of an automated driving mode or a driving assist mode at the timing of entry or passage of an own vehicle to the automated driving possible area or the driving assist possible area, and controls switching to the automated driving mode or the driving assist mode of the own vehicle.

### Means for Solving the Problem

Aspect 1: One or more embodiments of the invention propose a driving control system. The driving control system includes: a position information acquiring unit configured to acquire position information of an own vehicle; an another vehicle information acquiring unit configured to execute a communication connecting the vehicle to everything, and acquires information including position information of another vehicle and a driving control mode at that time; a storage unit that stores a high-precision map; a drawing processing unit configured to draw a region formed when a traveling trajectory in which the own vehicle has traveled in an automated driving mode or a driving assist mode and a traveling trajectory in which the other vehicle has traveled in the automated driving mode or the driving assist mode are plotted on the high-precision map; a driving control mode determining unit configured to determine a driving control mode, based on information including at least information on the region drawn by the drawing processing unit and the position information of the own vehicle; a notification unit configured to notify an occupant of the own vehicle of start of automated driving control or that driving assist control is possible when the own vehicle enters the region, and notify the occupant of the own vehicle of end of the automated driving control or the driving assist control when the own vehicle exits the region; and a driving control unit configured to start the automated driving control or the driving assist control when the own vehicle enters the region, and ends the automated driving control or the driving assist control when the own vehicle exits the region.
Aspect 2: One or more embodiments of the invention propose the driving control system, in which the drawing processing unit is configured to draw, on the high-precision map, a region in which the region formed upon the plotting on the high-precision map is approximated to a rectangle.
Aspect 3: One or more embodiments of the invention propose the driving control system, further including: a database configured to store information on the traveling trajectory in which the own vehicle has traveled in the automated driving mode or the driving assist mode, and the traveling trajectory in which the other vehicle has traveled in the automated driving mode or the driving assist mode; and a congestion time-zone information acquiring unit configured to acquire, based on the database, the traveling trajectory in which the own vehicle has traveled in the automated driving mode or the driving assist mode in a time zone of congestion and the traveling trajectory in which the other vehicle has traveled in the automated driving mode or the driving assist mode in the time zone of the congestion. The database is configured to store information including passage time information and information on a road type, a start point of automated driving, an end point of the automated driving, and an interruption point of the automated driving that are associated with each other. The drawing processing unit is configured to draw the region corresponding to the traveling trajectory in which the own vehicle has traveled in the automated driving mode or the driving assist mode in the time zone of the congestion and the traveling trajectory in which the other vehicle has traveled in the automated driving mode or the driving assist mode in the time zone of the congestion.
Aspect 4: One or more embodiments of the invention propose the driving control system, further including: a route searching unit configured to search for a route from a current position of the own vehicle to a destination, based on the high-precision map; and a display unit configured to display information including the searched route. The display unit is configured to display the region drawn by the drawing processing unit in a superimposed manner on the route.
Aspect 5: One or more embodiments of the invention propose the driving control system, further including a traffic information acquiring unit configured to acquire road construction section information and information on a traffic accident frequent occurrence point and a congestion prediction section. The display unit further is configured to display the information acquired by the traffic information acquiring unit in the superimposed manner on the route.

### Effects of the Invention

One or more embodiments of the invention have an effect in which it is possible to determine an automated driving possible area in real time while suppressing a processing load, to notify an occupant of start or end of an automated driving mode or a driving assist mode at a timing of entry of the own vehicle into the automated driving possible area or at a timing of passage of the own vehicle of the automated driving possible area, and to control switching to the automated driving mode or the driving assist mode of the own vehicle.

### BRIEF DESCRIPTION OF DRAWINGS

FIG. 1 is a diagram illustrating a configuration of a driving control system according to a first embodiment of the invention.

FIG. 2 is a diagram schematically illustrating a drawing process of a drawing processing unit of the driving control system according to the first embodiment of the invention.

FIG. 3 is a diagram illustrating a process flow of an in-vehicle device according to the first embodiment of the invention.

FIG. 4 is a diagram illustrating a process flow of a server according to the first embodiment of the invention.

FIG. 5 is a diagram illustrating a configuration of a driving control system according to a second embodiment of the invention.

FIG. 6 is a diagram illustrating, together with a route, a region drawn by the drawing processing unit according to the second embodiment of the invention.

FIG. 7 is a diagram illustrating a display mode of a display unit of the driving control system according to the second embodiment of the invention.

FIG. 8 is a diagram illustrating a display mode of the display unit of the driving control system according to the second embodiment of the invention.

### MODES FOR CARRYING OUT THE INVENTION

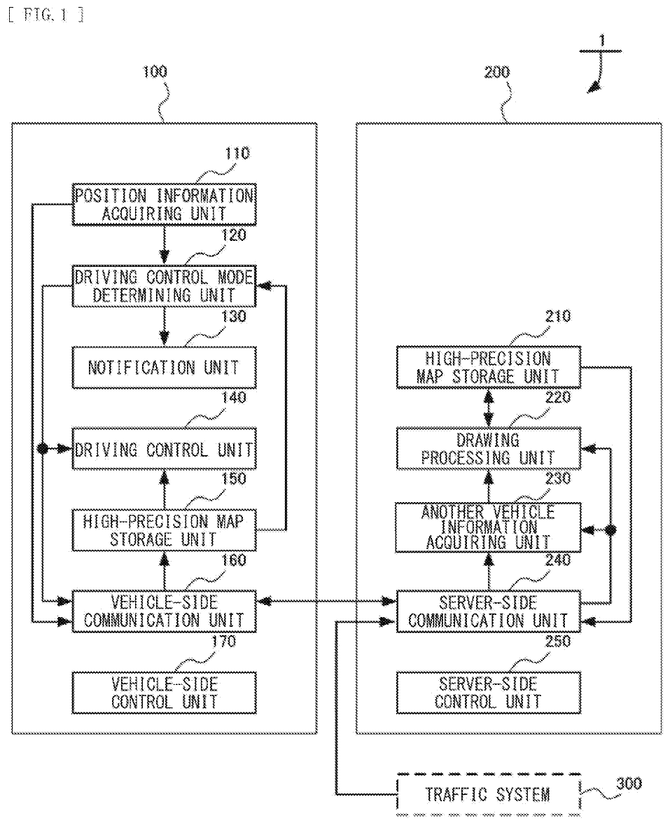

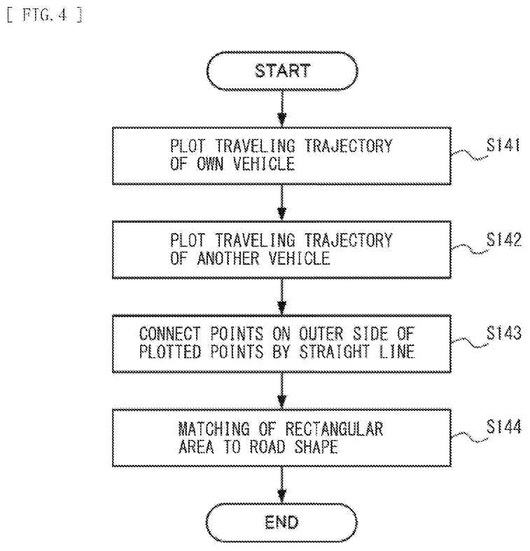

In the following, embodiments of the invention are described with reference to FIGS. 1 to 8.

### First Embodiment

Described is a driving control system 1 according to the present embodiment with reference to FIGS. 1 to 4.

<Configuration of Driving Control System 1>

As illustrated in FIG. 1, the driving control system 1 according to the present embodiment includes an in-vehicle device 100 and a server 200.

It should be noted that the in-vehicle device 100 will be described below assuming that a device similar thereto is mounted not only in an own vehicle but also in another vehicle.

The in-vehicle device 100 controls acquisition of current position information of the own vehicle, determination on a driving control mode based on information received from the later-described server 200, notification and start/end of a driving control corresponding to the determination on the driving control mode, etc.

The server 200 plots, on a high-precision map, a region formed when a traveled traveling trajectory is plotted by an automated driving control or a driving assist control, on the basis of position information and driving control mode information of the vehicle obtained from the in-vehicle device 100 and position information and driving control mode information of another vehicle obtained from a traffic system or the like, and transmits latest high-precision map information to the in-vehicle device 100 in real time.

<Configuration of In-Vehicle Device 100>

As illustrated in FIG. 1, the in-vehicle device 100 includes a position information acquiring unit 110, a driving control mode determining unit 120, a notification unit 130, a driving control unit 140, a high-precision map storage unit 150, a vehicle-side communication unit 160, and a vehicle-side control unit 170.

The position information acquiring unit 110 includes, for example, a GPS receiver, an azimuth sensor, a distance sensor, etc., and detects position information (longitude information and latitude information) of the own vehicle at a predetermined timing to acquire the position information of the own vehicle.

It should be noted that the position information of the own vehicle acquired by the position information acquiring unit 110 is outputted to the driving control mode determining unit 120 and the vehicle-side communication unit 160, which will be described later.

The driving control mode determining unit 120 determines a driving control mode by determining whether the own vehicle is within a region drawn by a later-described drawing processing unit 220 of the server 200, on the basis of the position information of the own vehicle acquired by the position information acquiring unit 110 and map information stored in the later-described high-precision map storage unit 150.

Specifically, for example, in a case where the own vehicle is within the region drawn by the drawing processing unit 220 of the server 200, the driving control mode determining unit 120 determines the driving control mode of the own vehicle as an automated driving control mode or a driving assist control mode, and transmits information to the notification unit 130 and the driving control unit 140, which will be described later, indicating that the driving control mode of the own vehicle is determined as being the automated driving control mode or the driving assist control mode.

It should be noted that the driving control mode determining unit 120 determines that the driving control mode of the own vehicle is the automated driving control mode or the driving assist control mode in a case where the automated driving control mode or the driving assist control mode is determined as being possible on the basis of sensor information, vehicle surrounding information, etc., even in a case where the own vehicle is outside the region drawn by the drawing processing unit 220 of the server 200, and transmits information to the notification unit 130, the driving control unit 140, and the vehicle-side communication unit 160, which will be described later, indicating that the driving control mode of the own vehicle is determined as being the automated driving control mode or the driving assist control mode.

The notification unit 130 notifies an occupant of the own vehicle of start of the automated driving control or that the driving assist control is possible when the own vehicle enters the region drawn by the drawing processing unit 220 of the server 200 on the basis of a determination result of the driving control mode determining unit 120, and notifies the occupant of the own vehicle of end of the automated driving control or the driving assist control when the own vehicle exits the region.

It should be noted that a method of the notification by the notification unit 130 may be performed by voice, display, or a combination of the voice and the display.

In addition, the notification unit 130 may be mounted not only on the in-vehicle device 100, but also on a mobile terminal such as a smartphone, a portable car navigation device, etc., for example.

The driving control unit 140 executes a driving control on the basis of a determination result received from the driving control mode determining unit 120. Specifically, the driving control unit 140 automatically executes a travel control such as a steering operation control, a speed control, or a brake control on the basis of the high-precision map information, the sensor information, the vehicle surrounding information, etc.

It should be noted that, as for the start of the driving assist control mode, it is preferable to start the driving assist control mode on the basis of an operation by the occupant such as a switch input or a voice input as a trigger, instead of automatically performing the determination.

The high-precision map storage unit 150 stores the high-precision map used for the automated driving control.

It should be noted that the map information stored in the high-precision map storage unit 150 is sequentially rewritten into the latest map information received from the server-side communication unit 240 of the server 200 via the later-described vehicle-side communication unit 160.

The vehicle-side communication unit 160 transmits and receives information to and from the later-described server-side communication unit 240 of the server 200. Specifically, the vehicle-side communication unit 160 transmits information such as the position information of the own vehicle or the driving control mode of the own vehicle to the server-side communication unit 240, and receives the high-precision map information, etc., from the server-side communication unit 240.

In addition, the map information stored in the high-precision map storage unit 150 in the in-vehicle device 100 is updated by the high-precision map information received from the server-side communication unit 240.

The vehicle-side control unit 170 controls the in-vehicle device 100 as a whole, on the basis of a control program stored in unillustrated ROM (Read Only Memory), etc.

It should be noted that, in the present embodiment, the vehicle-side control unit 170 controls an operation and a process of the position information acquiring unit 110, the driving control mode determining unit 120, the notification unit 130, the driving control unit 140, the vehicle-side communication unit 160, etc.

<Configuration of Server 200>

As illustrated in FIG. 1, the server 200 includes the high-precision map storage unit 210, the drawing processing unit 220, an another vehicle information acquiring unit 230, the server-side communication unit 240, and a server-side control unit 250.

The high-precision map storage unit 210 stores the high-precision map to which drawing information is added in the later-described drawing processing unit 220. The high-precision map information stored in the high-precision map storage unit 210 is transmitted to the vehicle-side communication unit 160 via the later-described server-side communication unit 240.

The drawing processing unit 220 draws a region formed when a traveling trajectory in which the own vehicle has traveled in the automated driving mode or the driving assist mode and a traveling trajectory in which another vehicle has traveled in the automated driving mode or the driving assist mode are plotted on the high-precision map, on the basis of information received from the vehicle-side communication unit 160, information received from the later-described another vehicle information acquiring unit 230, etc.

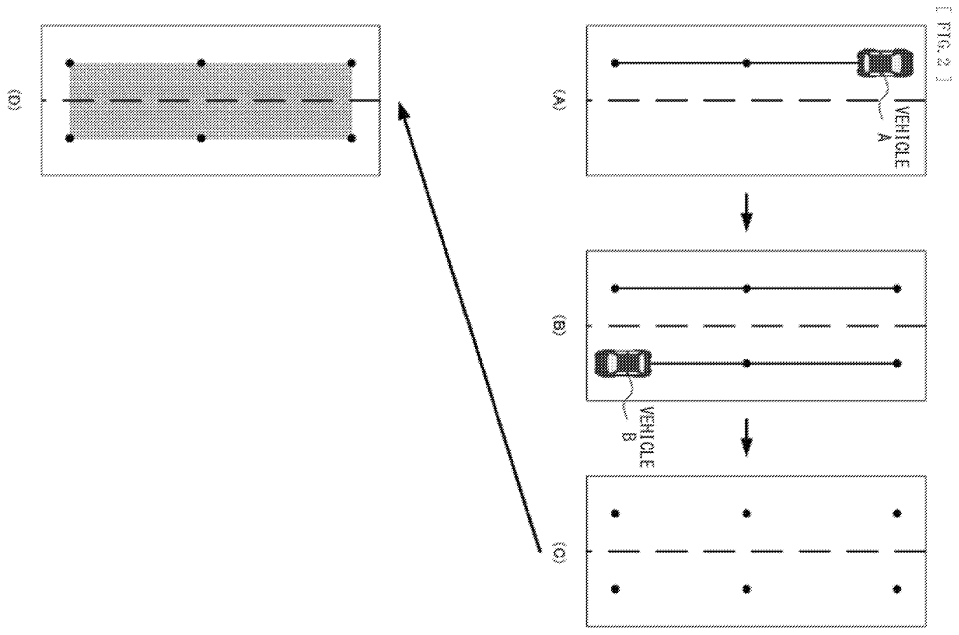

It should be noted that, as a drawing method of the drawing processing unit 220, as illustrated in FIG. 2, for example, in a case where a road of interest is a one-sided two-way road, first, the traveling trajectory in which a vehicle A as the own vehicle has traveled in the automated driving mode or the driving assist mode is plotted at a predetermined time interval ((A) of FIG. 2), following which the traveling trajectory in which a vehicle B has traveled in the automated driving mode or the driving assist mode along an oncoming lane is plotted at the predetermined time interval ((B) of FIG. 2), a rectangular area in which plotted points ((C) of FIG. 2) are connected by a line is drawn ((D) of FIG. 2), and the rectangular area of (D) of FIG. 2 is so deformed as to match a road shape to draw the region.

It should be noted that, in a case where there are traveling trajectories of a plurality of vehicles, there is a case where a clear rectangle is not formed. However, in that case, a graphic area formed by connecting the outermost points may be approximated to a rectangle and so deformed as to match the road shape to draw the region.

The another vehicle information acquiring unit 230 executes a communication connecting the vehicle to everything, and acquires information including position information of another vehicle and the driving control mode at that time. Specifically, for example, the another vehicle information acquiring unit 230 inputs another vehicle information from a traffic system 300 and acquires position information in which another vehicle has started traveling in the automated driving mode or the driving assist mode, position information in which another vehicle has ended the traveling in the automated driving mode or the driving assist mode, etc., via the later-described server-side communication unit 240, and outputs the information to the drawing processing unit 220.

Here, the “communication connecting the vehicle and everything” refers to, for example, a cellular V2X communication, a communication form in which 4G or 5G network access technology and a narrow-area communication (DSRC) technology are integrated, or a communication form in which the 4G or 5G network access technology, the narrow-area communication (DSRC) technology, and further the cellular V2X (C-V2X) communication technology are integrated.

The server-side communication unit 240 receives information such as the position information of the own vehicle or the driving control mode from the vehicle-side communication unit 160, receives the another vehicle information from the traffic system 300, and transmits the updated high-precision map information, etc., to the server-side communication unit 240.

The server-side control unit 250 controls the server 200 as a whole, on the basis of a control program stored in unillustrated ROM, etc.

It should be noted that, in the present embodiment, the server-side control unit 250 controls an operation and a process of the drawing processing unit 220, the another vehicle information acquiring unit 230, the server-side communication unit 240, etc.

<Process of Driving Control System 1>

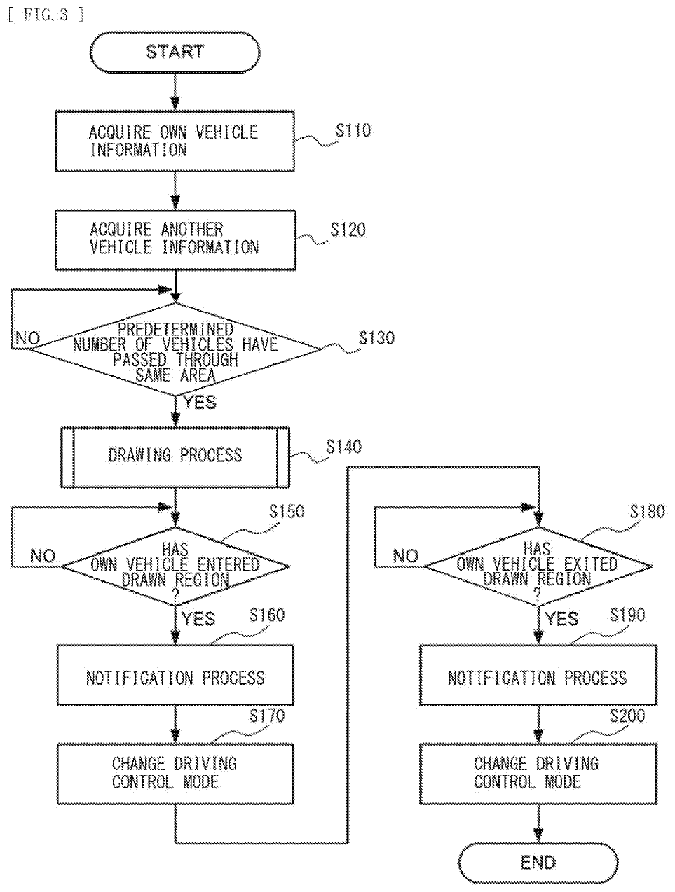

A process of the driving control system 1 according to the present embodiment will be described with reference to FIGS. 3 to 5.

As illustrated in FIG. 3, first, the drawing processing unit 220 of the server 200 acquires the own vehicle information, for example, the position information in which the own vehicle has started traveling in the automated driving mode or the driving assist mode, the position information in which the own vehicle has ended traveling in the automated driving mode or the driving assist mode, etc., via the vehicle-side communication unit 160 of the in-vehicle device 100 and the server-side communication unit 240 (step S110).

Next, the drawing processing unit 220 of the server 200 acquires the another vehicle information, for example, the position information in which another vehicle has started traveling in the automated driving mode or the driving assist mode, position information in which another vehicle has ended traveling in the automated driving mode or the driving assist mode, etc., via the server-side communication unit 240 and the another vehicle information acquiring unit 230 (step S120).

The drawing processing unit 220 of the server 200 determines whether a predetermined number or more of vehicles have passed through the same area (step S130). Here, it is possible to exemplify “the predetermined number or more of the vehicles have passed through the same area” by, for example, passage of about 10 vehicles through each lane in the automated driving control mode or the driving assistance control mode in a case of a one-sided two-way road.

Thereafter, in a case where the drawing processing unit 220 of the server 200 determines that the predetermined number or more of the vehicles have not passed through the same area (“NO” in step S130), the process is returned back for standby.

On the other hand, in a case where the drawing processing unit 220 of the server 200 determines that the predetermined number or more of the vehicles have passed through the same area (“YES” in step S130), the drawing processing unit 220 of the server 200 executes a drawing process (step S140) (step S130).

The driving control mode determining unit 120 of the in-vehicle device 100 determines whether the own vehicle has entered the region drawn by the drawing processing unit 220 of the server 200, on the basis of the position information of the own vehicle acquired by the position information acquiring unit 110 and the map information stored in the high-precision map storage unit 150 (step S150).

Thereafter, in a case where the driving control mode determining unit 120 determines that the own vehicle has not entered the region drawn by the drawing processing unit 220 of the server 200 (“NO” in step S150), the process is returned back for standby.

On the other hand, in a case where the driving control mode determining unit 120 determines that the own vehicle has entered the region drawn by the drawing processing unit 220 of the server 200 (“YES” in step S150), the driving control mode determining unit 120 outputs, to the notification unit 130 and the driving control unit 140, information indicating that the own vehicle has entered the region drawn by the drawing processing unit 220 of the server 200, and the notification unit 130 notifies the occupant of the own vehicle of the start of the automated driving control or that the driving assist control is possible (step S160). The driving control unit 140 switches the driving control mode to the automated driving control mode or the driving assist control mode (step S170).

Next, the driving control mode determining unit 120 determines whether the own vehicle has exited the region drawn by the drawing processing unit 220 of the server 200, on the basis of the position information of the own vehicle acquired by the position information acquiring unit 110 and the map information stored in the high-precision map storage unit 150 (step S180).

Thereafter, in a case where the driving control mode determining unit 120 determines that the own vehicle has not exited the region drawn by the drawing processing unit 220 of the server 200 (“NO” in step S180), the process is returned back for standby.

On the other hand, in a case where the driving control mode determining unit 120 determines that the own vehicle has exited the region drawn by the drawing processing unit 220 of the server 200 (“YES” in step S180), the driving control mode determining unit 120 outputs, to the notification unit 130 and the driving control unit 140, information indicating that the own vehicle has exited the region drawn by the drawing processing unit 220 of the server 200, and the notification unit 130 notifies the occupant of the own vehicle of the end of the automated driving control or the driving assist control (step S190). The driving control unit 140 switches the driving control mode to a non-automated driving control mode or a non-driving assist control mode (step S200).

<Process of Drawing Processing Unit 220>

The drawing processing unit 220 plots the traveling trajectory in which the own vehicle has traveled in the automated driving mode or the driving assist mode at the predetermined time interval, on the basis of the position information of the own vehicle received from the in-vehicle device 100 and the map information stored in the high-precision map storage unit 210 (step S141), following which the drawing processing unit 220 plots the traveling trajectory in which another vehicle has traveled in the automated driving mode or the driving assist mode at the predetermined time interval, on the basis of the position information of another vehicle received from the another vehicle information acquiring unit 230, etc., and the map information stored in the high-precision map storage unit 210 (step S142).

Next, the drawing processing unit 220 draws the rectangular area in which the plotted points are connected by a line (step S143), and so deforms the rectangular area drawn in step S143 as to match the road shape to draw the region (step S144).

<Workings and Effects>

As described above, the driving control system 1 according to the present embodiment includes: the drawing processing unit 220 that draws the region formed when the traveling trajectory in which the own vehicle has traveled in the automated driving mode or the driving assist mode and the traveling trajectory in which another vehicle has traveled in the automated driving mode or the driving assist mode are plotted on the high-precision map; the driving control mode determining unit 120 that determines the driving control mode, on the basis of the information including the information on the region drawn by the drawing processing unit 220 and the position information of the own vehicle; the notification unit 130 that notifies the occupant of the own vehicle of the start of the automated driving control or that the driving assist control is possible when the own vehicle enters the drawn region, and notifies the occupant of the own vehicle of the end of the automated driving control or the driving assist control when the own vehicle exits the drawn region; and the driving control unit 140 that starts the automated driving control or the driving assist control when the own vehicle enters the drawn region, and ends the automated driving control or the driving assist control when the own vehicle exits the drawn region.

That is, the drawing processing unit 220 draws the region formed when the traveling trajectory in which the own vehicle has traveled in the automated driving mode or the driving assist mode and the traveling trajectory in which another vehicle has traveled in the automated driving mode or the driving assist mode are plotted on the high-precision map.

Thus, it is possible to clarify a region in which the automated driving control or the driving assist control of the vehicle is possible.

In addition, the drawing processing unit 220 draws the region formed when the traveling trajectory in which the own vehicle has traveled in the automated driving mode or the driving assist mode and the traveling trajectory in which another vehicle has traveled in the automated driving mode or the driving assist mode are plotted on the high-precision map, making it possible to clarify the region in which the automated driving control or the driving assist control of the vehicle is possible without executing a high-load data processing.

Further, the notification unit 130 notifies the occupant of the start of the automated driving control or that the driving assist control is possible, notifies the occupant of the end of the automated driving control or the driving assist control, and provides the information on the start or the end of the automated driving control to the driving control unit 140, upon the entry of the own vehicle to or the passage of the own vehicle of the region drawn by the drawing processing unit 220 and formed when the traveling trajectory in which the own vehicle has traveled in the automated driving mode or the driving assist mode and the traveling trajectory in which another vehicle has traveled in the automated driving mode or the driving assist mode are plotted on the high-precision map.

Thus, it is possible to accurately notify the occupant of the start or the end of the automated driving mode or the driving assist mode at the timing of the entry of the own vehicle into an automated driving possible region or a driving assist possible region or at the timing of the passage of the own vehicle of the automated driving possible region or the driving assist possible region, and to appropriately control the switching to the automated driving mode or the driving assist mode of the own vehicle.

Accordingly, it is possible to determine the automated driving possible area in real time while suppressing a processing load, to notify the occupant of the start or the end of the automated driving mode or the driving assist mode at the timing of the entry of the own vehicle into the automated driving possible area or the driving assist possible area or at the timing of the passage of the own vehicle of the automated driving possible area or the driving assist possible area, and to control the switching to the automated driving mode or the driving assist mode of the own vehicle.

Further, in the driving control system 1 according to the present embodiment, the drawing processing unit 220 draws, on the high-precision map, the region in which the region formed upon the plotting on the high-precision map is approximated to the rectangle.

Accordingly, it is possible to easily and accurately recognize the timing of the entry or the timing of the passage of the own vehicle with respect to an automated driving controllable region or a driving assist controllable region which is the rectangular region.

### Second Embodiment

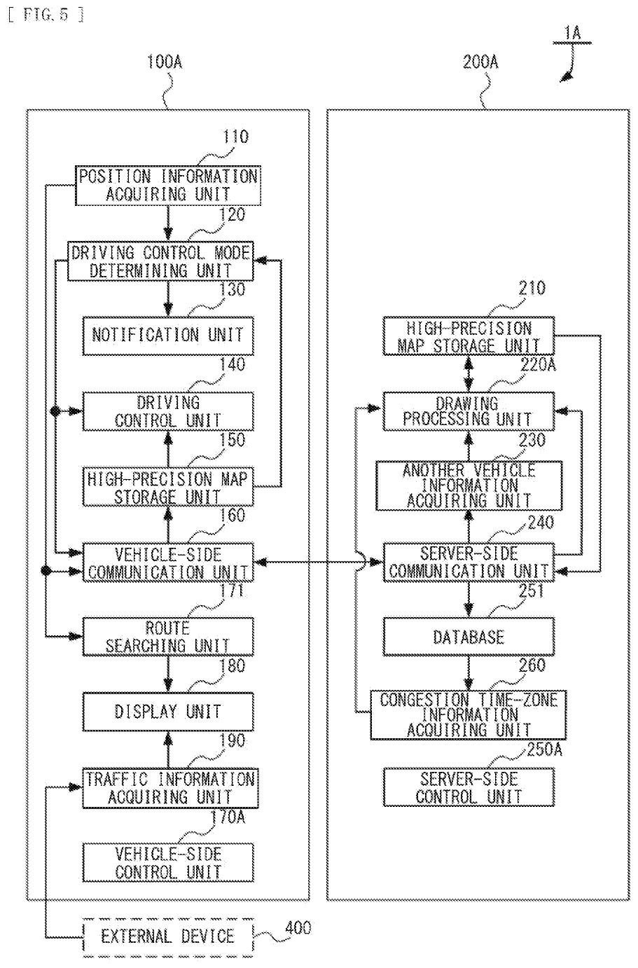

A driving control system 1A according to the present embodiment will be described with reference to FIGS. 5 to 8.

<Configuration of In-Vehicle Device 100A>

As illustrated in FIG. 5, the in-vehicle device 100A includes the position information acquiring unit 110, the driving control mode determining unit 120, the notification unit 130, the driving control unit 140, the high-precision map storage unit 150, the vehicle-side communication unit 160, a route searching unit 171, a display unit 180, a traffic information acquiring unit 190, and a vehicle-side control unit 170A.

It should be noted that, because elements denoted with the same reference numerals as the first embodiment have similar functions, a detailed description thereof will be omitted.

The route searching unit 171 searches for a route from a current position of the own vehicle to the destination on the basis of the high-precision map. Specifically, the route searching unit 171 searches for the route from the current position of the own vehicle to the destination on the basis of the current position information of the vehicle acquired by the position information acquiring unit 110, position information on the destination inputted and instructed from the occupant, and the high-precision map.

The display unit 180 is configured by, for example, a liquid crystal panel, etc., and so displays information including the route searched by the route searching unit 171 as to be visible to the occupant.

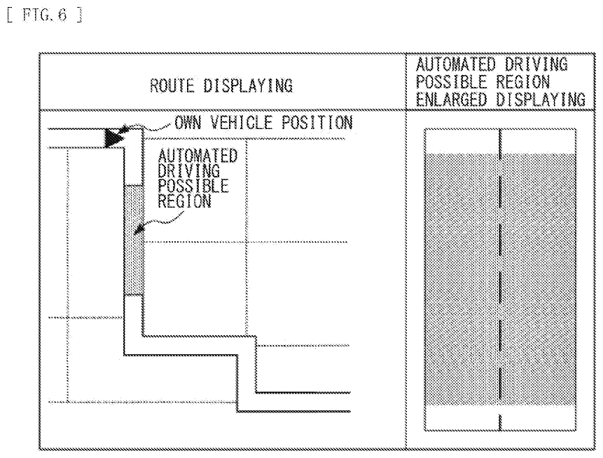

In addition, as illustrated in FIG. 6, the display unit 180 displays the region drawn by the drawing processing unit 220 in a superimposed manner on the route.

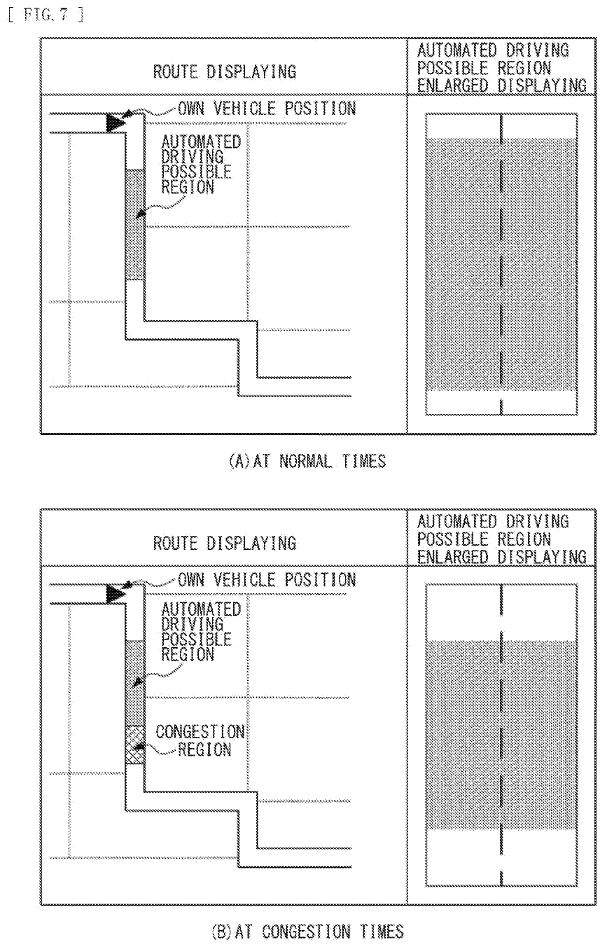

Further, as illustrated in (B) of FIG. 7, the display unit 180 displays the region drawn by the drawing processing unit 220 in a superimposed manner on the route, on the basis of information acquired by a later-described congestion time-zone information acquiring unit 260.

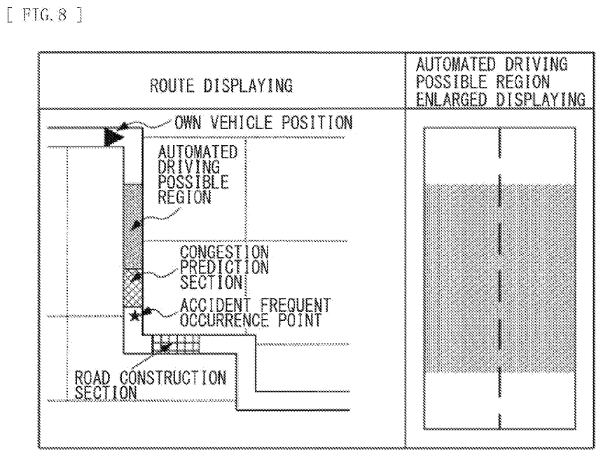

In addition, as illustrated in FIG. 8, the display unit 180 displays the region drawn by the drawing processing unit 220 and traffic information acquired by the later-described traffic information acquiring unit 190 in a superimposed manner on the route.

It should be noted that, with regard to prediction information or real-time information on a commuting congestion during a time zone in the morning and the evening of the weekdays, prediction information or real-time information on a freeway congestion during daytime hours of holidays, real-time information on traffic congestion due to the weather and disaster, planned or sudden road construction information, etc., a high-precision map of a map dealer to which such pieces of information are added may be obtained, and with regard to information on frequent occurrence points of traffic accidents, a high-precision map created by a police or a local government having jurisdiction over each respective road and to which such information is added may be obtained from the police or the local government, and the region drawn by the later-described drawing processing unit 220A may be superimposed on the obtained map.

The traffic information acquiring unit 190 acquires, from an external device 400, road construction section information and information on a traffic accident frequent occurrence point and a congestion prediction section, for example.

The vehicle-side control unit 170A controls the in-vehicle device 100A as a whole, on the basis of a control program stored in an unillustrated ROM, etc.

It should be noted that, in the present embodiment, the vehicle-side control unit 170A controls an operation and a process of the position information acquiring unit 110, the driving control mode determining unit 120, the notification unit 130, the driving control unit 140, the vehicle-side communication unit 160, the route searching unit 171, the display unit 180, the traffic information acquiring unit 190, etc.

<Configuration of Server 200A>

As illustrated in FIG. 5, the server 200 includes the high-precision map storage unit 210, a drawing processing unit 220A, the another vehicle information acquiring unit 230, the server-side communication unit 240, a database 251, the congestion time-zone information acquiring unit 260, and a server-side control unit 250A.

It should be noted that, because elements denoted with the same reference numerals as the first embodiment have similar functions, a detailed description thereof will be omitted.

The database 251 stores, in a database format, information on a traveling trajectory in which the own vehicle has traveled in the automated driving mode or the driving assist mode, and a traveling trajectory in which another vehicle has traveled in the automated driving mode or the driving assist mode.

In the database 251, passage time information of the region drawn by the drawing processing unit 220 and information on a road type, a start point of the automated driving, an end point of the automated driving, and an interruption point of the automated driving are stored in association with each other.

The congestion time-zone information acquiring unit 260 acquires, on the basis of the database 251, a traveling trajectory in which the own vehicle has traveled in the automated driving mode or the driving assist mode in a time zone of congestion and a traveling trajectory in which another vehicle has traveled in the automated driving mode or the driving assist mode in the time zone of the congestion.

Specifically, for example, the congestion time-zone information acquiring unit 260 acquires the traveling trajectory in which the own vehicle has traveled in the automated driving mode or the driving assist mode and the traveling trajectory in which another vehicle has traveled in the automated driving mode or the driving assist mode, in an area where the congestion is predicted on weekdays or holidays using the passage time information in the database 251 as a key.

The drawing processing unit 220A draws a region corresponding to the traveling trajectory in which the own vehicle has traveled in the automated driving mode or the driving assist mode and the traveling trajectory in which another vehicle has traveled in the automated driving mode or the driving assist mode in the time zone of the congestion.

The server-side control unit 250A controls the in-vehicle device 100A as a whole, on the basis of a control program stored in an unillustrated ROM, etc.

It should be noted that, in the present embodiment, the server-side control unit 250A controls an operation and a process of the drawing processing unit 220A, the another vehicle information acquiring unit 230, the server-side communication unit 240, the congestion time-zone information acquiring unit 260, etc.

<Workings and Effects>

As described above, the driving control system 1A according to the present embodiment includes the congestion time-zone information acquiring unit 260 that acquires the traveling trajectory in which the own vehicle has traveled in the automated driving mode or the driving assist mode in the time zone of the congestion and the traveling trajectory in which another vehicle has traveled in the automated driving mode or the driving assist mode in the time zone of the congestion, on the basis of the database 251 that stores the information on the traveling trajectory in which the own vehicle has traveled in the automated driving mode or the driving assist mode and the traveling trajectory in which another vehicle has traveled in the automated driving mode or the driving assist mode. In the database 251, the passage time information and the information on the road type, the start point of the automated driving, the end point of the automated driving, and the interruption point of the automated driving are stored in association with each other. The drawing processing unit 220A draws the region corresponding to the traveling trajectory in which the own vehicle has traveled in the automated driving mode or the driving assist mode in the time zone of the congestion and the traveling trajectory in which another vehicle has traveled in the automated driving mode or the driving assist mode in the time zone of the congestion.

That is, because the drawing processing unit 220A draws the region in real time, as illustrated in FIG. 7, the drawing processing unit 220A draws the region corresponding to a plurality of time zones (a commuting time zone in the morning and the evening, a time of weather failure, weekdays and holidays, etc.) for the same area in a normal time zone, a time zone of congestion, or the like.

Accordingly, even in a situation different from a normal situation, it is possible to determine the automated driving possible area or the driving assist possible area in real time while suppressing a processing load, to notify the occupant of the start or the end of the automated driving mode or the driving assist mode at the timing of the entry of the own vehicle into the automated driving possible area or the driving assist possible area or the passage of the own vehicle of the automated driving possible area or the driving assist possible area, and to control the switching to the automated driving mode or the driving assist mode of the own vehicle.

Further, in the driving control system 1A according to the present embodiment, the display unit 180 that displays the information including the searched route displays the region drawn by the drawing processing unit 220A in a superimposed manner on the route searched by the route searching unit 171 that searches for the route from the current position of the own vehicle to the destination on the basis of the high-precision map.

That is, for example, as illustrated in FIG. 6, the display unit 180 displays the region drawn by the drawing processing unit 220A in such a manner as to be superimposed on the route searched by the route searching unit 171.

Accordingly, it is possible for the occupant to easily predict at what timing the control mode of the vehicle is switched to the automated driving mode or the driving assist mode or at what timing the automated driving control mode or the driving assist control mode is to be released by visually seeing the draw region together with a position of the own vehicle displayed on the display unit 180.

Further, in the driving control system 1A according to the present embodiment, the display unit 180 further displays, in a superimposed manner on the route, the road construction section information and the information on the traffic accident frequent occurrence point and the congestion prediction section acquired by the traffic information acquiring unit 190.

That is, for example, as illustrated in FIG. 8, the display unit 180 further displays the road construction section information and the information on the traffic accident frequent occurrence point and the congestion prediction section in a superimposed manner on the route.

Accordingly, it is possible for the occupant to easily predict, for example, a possibility that the automated driving possible region or the driving assist controllable region becomes narrower or wider in the future from the display information on the display unit 180.

### Modification Example 1

In the first embodiment, the description has been provided in which the notification unit 130 notifies the occupant of the start of the automated driving control or that the driving assist control is possible and notifies the occupant of the end of the automated driving control or the driving assist control upon the entry of the own vehicle to or the passage of the own vehicle of the region drawn by the drawing processing unit 220 and formed when the traveling trajectory in which the own vehicle has traveled in the automated driving mode or the driving assist mode and the traveling trajectory in which another vehicle has traveled in the automated driving mode or the driving assist mode are plotted on the high-precision map, and controls the start of the automated driving control or the driving assist control or the end of the automated driving or the driving assist.

However, because the region is rectangular and it is possible to easily and accurately recognize the timing of the entry or the timing of the passage of the own vehicle with respect to the automated driving controllable region or the driving assist controllable region as the rectangular region, the notification unit 130 may notify the occupant in advance that the automated driving control or the driving assist control is enabled before the entry or the passage of the own vehicle, or that the automated driving control or the driving assist control is soon ended.

### Modification Example 2

In the second embodiment, the description has been provided in which the display unit 180 displays the region drawn by the drawing processing unit 220 in a superimposed manner on the route.

However, in a case where the display unit 180 displays the region drawn by the drawing processing unit 220 in a superimposed manner on the route, in addition thereto, the rectangular region as the automated driving possible region or the driving assist controllable region may be enlarged and displayed as illustrated in FIG. 6, etc. In this way, in addition to displaying the region drawn by the drawing processing unit 220 in a superimposed manner on the route, enlarging and displaying the rectangular region as the automated driving possible region or the driving assist controllable region make it possible for the occupant to intuitively recognize that the own vehicle soon enters the automated driving possible region or the driving assist controllable region, or that the own vehicle soon exits the automated driving possible region or the driving assist controllable region.

### Modification Example 3

In the second embodiment, the description has been provided in which the display unit 180 displays the region drawn by the drawing processing unit 220 and the information acquired by the traffic information acquiring unit 190 in a superimposed manner on the route as illustrated in (B) of FIG. 7.

However, the display unit 180 may display the region drawn by the drawing processing unit 220 and congestion region information acquired by the traffic information acquiring unit 190 in a superimposed manner on the route as illustrated in (B) of FIG. 7. By performing such displaying, it is possible to intuitively allow the occupant to recognize that the automated driving possible region or the driving assist controllable region is narrower than at normal times when the congestion occurs, and that a factor that the automated driving possible region or the driving assist controllable region is narrower when the congestion occurs is due to an influence of the congestion, etc.

### Modification Example 4

In the first embodiment, the drawing processing unit 220 draws the region formed when the traveling trajectory in which the own vehicle has traveled in the automated driving mode or the driving assist mode and the traveling trajectory in which another vehicle has traveled in the automated driving mode or the driving assist mode are plotted on the high-precision map on the basis of the information received from the vehicle-side communication unit 160, the information received from the another vehicle information acquiring unit 230, etc., and the driving control mode determining unit 120, the notification unit 130, and the driving control unit 140 perform the determination process, the notification process, and the driving control process using the region drawn by the drawing processing unit 220.

However, the driving control mode determining unit 120, the notification unit 130, and the driving control unit 140 may perform the determination process, the notification process, and the driving control process using a region created by another vehicle or a region created by another person. In other words, using the communication connecting the vehicle and everything makes it possible to obtain the region created by another vehicle or another person. If it is possible to acquire various pieces of region information, it is possible to quickly perform a control on a region that has not been created, a region in a creation process, etc., in the own vehicle.

It should be noted that is possible to implement the driving control system 1 or 1A of the invention by recording the process to be executed by the vehicle-side control unit 170 or 170A and the server-side control unit 250 or 250A on a recording medium readable by a computer system, and causing the computer system to load the program recorded on the recording medium onto the vehicle-side control unit 170 or 170A and the server-side control unit 250 or 250A to execute the program. The computer system as used herein encompasses an OS and a hardware such as a peripheral device.

In addition, in a case where the computer system utilizes WWW (World Wide Web) system, the “computer system” shall encompass a website providing environment (or a website displaying environment). Further, the program may be transmitted from a computer system that stores the program in a storage device or the like to another computer system via a transmission medium or by a carrier wave in a transmission medium. The “transmission medium” that transmits the program refers to a medium having a function of transmitting information, including a network (a communication network) such as the Internet and a communication link (a communication line) such as a telephone line.

Further, the program may be directed to implement a part of the function described above. Moreover, the program may be a so-called differential file (differential program) configured to implement the function by a combination of a program already recorded on the computer system.

Although embodiments of the invention have been described in the foregoing with reference to the drawings, a specific configuration is not limited to that of the embodiment, and a design, etc., within the scope that does not depart from the gist of the invention shall be included as well.

### DESCRIPTION OF REFERENCE NUMERALS

1: Driving control system
1A: Driving control system
100: In-vehicle device
100A: In-vehicle device
110: Position information acquiring unit
120: Driving control mode determining unit
130: Notification unit
140: Driving control unit
150: High-precision map storage unit
160: Vehicle-side communication unit
170: Vehicle-side control unit
170A: Vehicle-side control unit
171: Route searching unit
180: Display unit
190: Traffic information acquiring unit
200: Server
200A: Server
210: High-precision map storage unit
220: Drawing processing unit
220A: Drawing processing unit
230: Another vehicle information acquiring unit
240: Server-side communication unit
251: Database
260: Congestion time-zone information acquiring unit
250: Server-side control unit
250A: Server-side control unit

1. A driving control system comprising:
a position information acquiring unit configured to acquire position information of an own vehicle;
an another vehicle information acquiring unit configured to execute a communication connecting the vehicle to everything, and acquire information including position information of another vehicle and a driving control mode at that time;
a storage unit that stores a high-precision map;
a drawing processing unit configured to draw a region formed when a traveling trajectory in which the own vehicle has traveled in an automated driving mode or a driving assist mode and a traveling trajectory in which the other vehicle has traveled in the automated driving mode or the driving assist mode are plotted on the high-precision map;
a driving control mode determining unit configured to determine a driving control mode, based on information including at least information on the region drawn by the drawing processing unit and the position information of the own vehicle;
a notification unit configured to notify an occupant of the own vehicle of start of automated driving control or that driving assist control is possible when the own vehicle enters the region, and notify the occupant of the own vehicle of end of the automated driving control or the driving assist control when the own vehicle exits the region; and
a driving control unit configured to start the automated driving control or the driving assist control when the own vehicle enters the region, and ends the automated driving control or the driving assist control when the own vehicle exits the region.

2. The driving control system according to claim 1, wherein the drawing processing unit is configured to draw, on the high-precision map, a region in which the region formed upon the plotting on the high-precision map is approximated to a rectangle.

3. The driving control system according to claim 1, further comprising:
a database configured to store information on the traveling trajectory in which the own vehicle has traveled in the automated driving mode or the driving assist mode, and the traveling trajectory in which the other vehicle has traveled in the automated driving mode or the driving assist mode; and
a congestion time-zone information acquiring unit configured to acquire, based on the database, the traveling trajectory in which the own vehicle has traveled in the automated driving mode or the driving assist mode in a time zone of congestion and the traveling trajectory in which the other vehicle has traveled in the automated driving mode or the driving assist mode in the time zone of the congestion, wherein
the database is configured to store information including passage time information and information on a road type, a start point of automated driving, an end point of the automated driving, and an interruption point of the automated driving that are associated with each other, and
the drawing processing unit is configured to draw the region corresponding to the traveling trajectory in which the own vehicle has traveled in the automated driving mode or the driving assist mode in the time zone of the congestion and the traveling trajectory in which the other vehicle has traveled in the automated driving mode or the driving assist mode in the time zone of the congestion.

4. The driving control system according to claim 3, further comprising:
a route searching unit configured to search for a route from a current position of the own vehicle to a destination, based on the high-precision map; and
a display unit configured to display information including the searched route, wherein
the display unit is configured to display the region drawn by the drawing processing unit in a superimposed manner on the route.

5. The driving control system according to claim 4, further comprising a traffic information acquiring unit configured to acquire road construction section information and information on a traffic accident frequent occurrence point and a congestion prediction section, wherein
the display unit is configured to further display the information acquired by the traffic information acquiring unit in the superimposed manner on the route.

6. The driving control system according to claim 2, further comprising:
a database configured to store information on the traveling trajectory in which the own vehicle has traveled in the automated driving mode or the driving assist mode, and the traveling trajectory in which the other vehicle has traveled in the automated driving mode or the driving assist mode; and
a congestion time-zone information acquiring unit configured to acquire, based on the database, the traveling trajectory in which the own vehicle has traveled in the automated driving mode or the driving assist mode in a time zone of congestion and the traveling trajectory in which the other vehicle has traveled in the automated driving mode or the driving assist mode in the time zone of the congestion, wherein
the database is configured to store information including passage time information and information on a road type, a start point of automated driving, an end point of the automated driving, and an interruption point of the automated driving that are associated with each other, and
the drawing processing unit is configured to draw the region corresponding to the traveling trajectory in which the own vehicle has traveled in the automated driving mode or the driving assist mode in the time zone of the congestion and the traveling trajectory in which the other vehicle has traveled in the automated driving mode or the driving assist mode in the time zone of the congestion.

7. The driving control system according to claim 6, further comprising:
a route searching unit configured to search for a route from a current position of the own vehicle to a destination, based on the high-precision map; and
a display unit configured to display information including the searched route, wherein
the display unit is configured to display the region drawn by the drawing processing unit in a superimposed manner on the route.

8. A driving control system comprising circuitry storing a high-precision map, the circuitry being configured to
acquire position information of an own vehicle,
execute a communication connecting the vehicle to everything, and acquire information including position information of another vehicle and a driving control mode at that time,
draw a region formed when a traveling trajectory in which the own vehicle has traveled in an automated driving mode or a driving assist mode and a traveling trajectory in which the other vehicle has traveled in the automated driving mode or the driving assist mode are plotted on the high-precision map,
determine a driving control mode, based on information including at least information on the drawn region and the position information of the own vehicle,
notify an occupant of the own vehicle of start of automated driving control or that driving assist control is possible when the own vehicle enters the region, and notify the occupant of the own vehicle of end of the automated driving control or the driving assist control when the own vehicle exits the region; and
start the automated driving control or the driving assist control when the own vehicle enters the region, and ends the automated driving control or the driving assist control when the own vehicle exits the region.
